(19) United States
(12) Patent Application Publication
(10) Pub. No.: US 2020/0249008 A1
(43) Pub. Date: Aug. 6, 2020

(54) METHODS AND DEVICES FOR ADDING POLARIZATION SENSING FUNCTION TO STANDARD LOW COHERENCE INTERFEROMETRY

(71) Applicant: THE REGENTS OF THE UNIVERSITY OF CALIFORNIA, Oakland, CA (US)

(72) Inventors: Zhongping Chen, Irvine, CA (US); Sucbei Moon, Irvine, CA (US); Yusi Miao, Irvine, CA (US)

(21) Appl. No.: 16/782,437

(22) Filed: Feb. 5, 2020

Related U.S. Application Data
(60) Provisional application No. 62/801,364, filed on Feb. 5, 2019.

(51) Int. Cl. G01B 9/02

(52) U.S. Cl. CPC G01B 9/02091; G01B 2290/45; G01B 2290/70; G01B 9/02004

(57) ABSTRACT

The present invention describes a scheme of reconfiguring an ordinary OCT system to a PS-OCT variant. In this scheme, a polarization mode-dependent optical delay (PMOD) unit is inserted at the sample arm of the OCT interferometer. As a consequence of its large retardation, the resulted OCT image contains a plurality of image replicas separated by the group delay difference of the polarization modes. The polarization-sensitive interference can be analyzed by the amplitude ratios between the replicated images. Because of the simplicity of this method, an ordinary OCT system can be easily and cost-effectively reconfigured to add a useful PS-OCT imaging function. This method can be applied to any low coherence interferometric technique such as spectral-domain OCT, time-domain OCT, and spectral-encoded microscopy.

### CROSS-REFERENCES TO RELATED APPLICATIONS

This application is a non-provisional and claims benefit of U.S. Provisional Application No. 62/801,364 filed Feb. 5, 2019, the specification(s) of which is/are incorporated herein in their entirety by reference.

### STATEMENT REGARDING FEDERALLY SPONSORED RESEARCH OR DEVELOPMENT

This invention was made with government support under Grant No. HL125084 awarded by the National Institutes of Health. The government has certain rights in the invention.

### BACKGROUND OF THE INVENTION

Optical coherence tomography (OCT) is a high-resolution, non-invasive, high-speed optical imaging modality. OCT has been applied in ophthalmology, cardiology, gastroenterology, dermatology, otolaryngology, and gynecology. Polarization-sensitive optical coherence tomography (PS-OCT) is a functional extension of OCT. PS-OCT provides a variety of opportunities in tissue imaging with its unique capability of acquiring depth-resolved sample birefringence. However, difficulties in system implementation and managements are major obstacles in clinical applications and commercial use. Bulk-optic construction of PS-OCT, frequently used in early developments, is not compatible to a majority of fiber-optic technologies. Various techniques have been developed so far for fiber-based construction of PS-OCT systems with polarization-maintaining (PM) fibers or common single-mode (SM) fibers. In one of the prominent schemes, a swept-source OCT (SS-OCT) system based on SM fibers equips a passive delay unit (PDU) which produces polarization-dependent delays of the OCT signal. The PDU is made of bulk-optic elements or a long section of PM fiber. Detected by polarization-diverse paired balanced photodetectors, full polarization information can be acquired simultaneously. By help of polarization tracking and auto-calibration techniques, such a system is designed to operate robust against systematic variations of polarization properties. However, it still has a specialized design with added system complexity compared to ordinary SS-OCT systems.

In many of cost-sensitive applications, such an elegant but complicated approach can be a luxury. A low-cost and ready-to-use technology that takes advantage of the present OCT systems while providing a most important but limited number of polarization properties may meet the demand.

### FIELD OF THE INVENTION

The present invention relates to methods and devices for optical coherence tomography (OCT). More specifically, the present invention relates to methods and devices for polarization sensing optical coherence tomography (PS-OCT).

### BRIEF SUMMARY OF THE INVENTION

It is an objective of the present invention systems, methods, and devices to provide that allow for polarization sensing optical coherence tomography (PS-OCT) which do not require polarization sensitive detectors, as specified in the independent claims. Embodiments of the invention are given in the dependent claims. Embodiments of the present invention can be freely combined with each other if they are not mutually exclusive.

The present invention features a very simple method of constructing a polarization-sensitive optical coherence tomography (PS-OCT), a medical device for investigating polarization properties of tissue. Using the method of the present invention, any ordinary non-polarization sensitive OCT system can be reconfigured to PS-OCT by inserting a polarization mode-dependent delay unit in the sample arm. Two polarization modes of a large group-delay difference form spatially distinguished polarization channels, removing the necessity to use a specialized polarization-sensitive detector. The depth-encoded information on the polarization states can be retrieved by an amplitude-based analysis, making the post-processing of the signal simpler. This method provides an economic and powerful scheme of acquiring polarization properties of tissue samples. It has been demonstrated that any ordinary OCT system can be easily reconfigured for PS-OCT imaging if it has sufficient margins in the imaging range.

Compared to other PS-OCT systems in the field, this method is much simpler and requires no additional hardware component. Most PS-OCT systems use a pair of specialized detectors distinguished by polarization optics. The present invention only requires a standard build-in detector since PMOD unit gives a temporally (or spatially) multiplexed detection of two polarization signals.

In addition, compared to other PS-OCT systems, the post-processing for the present invention is less complicated and can be done faster. The new approach controls and limits the polarization state at the sample incidence to only one orthogonal direction through a PMOD unit and a polarization alignment procedure, so the interpretation of polarization properties can be achieved easier and faster compare to other PS-OCT systems which use an uncontrolled polarization state at the sample.

One of the unique and inventive technical features of the present invention is the inclusion of a polarization delay unit in the OCT sample arm. Without wishing to limit the invention to any theory or mechanism, it is believed that the technical feature of the present invention advantageously provides for a double pass of the sample beam through the delay unit so as to allow for multiplex polarization sensitive OCT imaging without the use of a polarization sensitive detector. None of the presently known prior references or work has the unique inventive technical feature of the present invention. Furthermore, the prior references teaches away from the present invention. For example, the prior art teaches multiplexing using a polarization delay is problematic because of the risk of bad image quality if there is overlap of the delayed signals.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The patent application or application file contains at least one drawing executed in color. Copies of this patent or patent application publication with color drawing(s) will be provided by the Office upon request and payment of the necessary fee.

The features and advantages of the present invention will become apparent from a consideration of the following detailed description presented in connection with the accompanying drawings in which:

FIG. 1A shows an illustration of the reconfiguration of a swept-source OCT system to a PS-OCT system by adding a passive fiber-based optical delay.

FIG. 1B shows an illustration of the reconfiguration of a spectral-domain OCT system to a PS-OCT system by adding a bulk optics-based optical delay.

FIG. 2 shows the expected OCT image as a result of placing a polarization mode-dependent optical delay unit. Fast-Fast (FF) image will form when the light propagates through fast axis only. Slow-Slow (SS) image will form when the light propagates through slow axis only. Fast-Slow (FS) image will form when the light propagates through fast axis in one way and slow axis in another way.

FIG. 3A shows an illustration of a bulk optics-based polarization delay unit. Δz/2 indicates the optical path differences of two mirrors.

FIG. 3B shows an illustration of a bulk optics-based polarization delay unit including quarter wave plates. Δz/2 indicates the optical path differences of two mirrors.

FIG. 4A shows a schematic illustration of a standard OCT system.

FIG. 4B shows a schematic illustration of a reconfigured OCT system.

FIG. 5 shows an OCT B-scan image and intensity profile of a finger acquired from the proposed polarization sensitive system.

FIG. 6 shows an OCT B-scan image, reflectivity, and retardation signal of rabbit tendon and muscle was demonstrated using the proposed polarization sensitive system.

### DETAILED DESCRIPTION OF THE INVENTION

The present invention describes methods and devices to reconfigure a traditional OCT device without polarization sensing function to a polarization-sensitive OCT using a polarization mode-dependent optical delay (PMOD) unit (204). The invention requires minimum modification of hardware and software to the original OCT device, and thus is an economic and less-complex scheme of acquiring polarization properties.

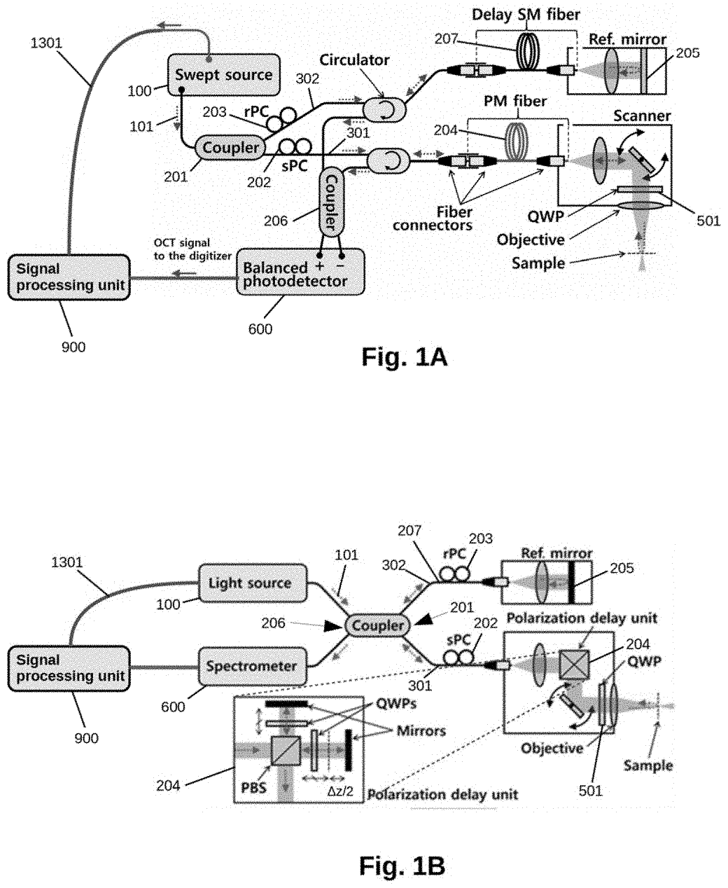

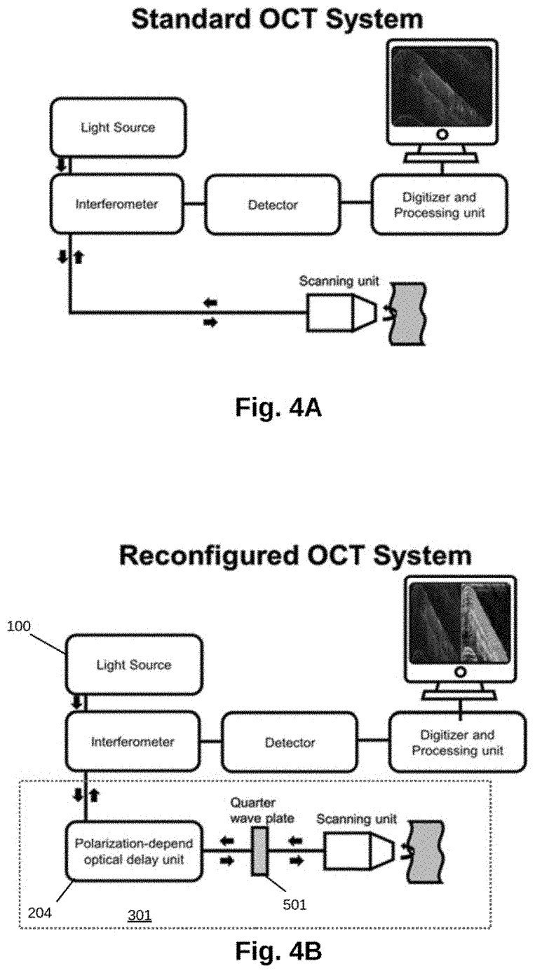

Referring now to FIG. 1A, FIG. 1B, FIG. 4A and FIG. 4B, the present invention features methods by which any standard OCT system can be reconfigured to a PS-OCT system with an addition of polarization-dependent optical delay unit (204) in the sample arm (301). Quarter wave plate (501) makes the sample illumination light circular polarized and allows quantitative birefringence measurement. For qualitative assessment of birefringence signal, quarter wave plate (501) is not needed.

In one embodiment the present invention may feature a polarization sensitive optical coherence tomography (PS-OCT) system. As a non-limiting example, the system may comprise: a light source (100), an optical splitter (201), a sample arm (301), a reference arm (302), an optical combiner (206), a polarization-insensitive photodetector (600), and a signal processing unit (900). In some embodiments, the light source (100) may be configured to produce a polarized light beam (101). In some embodiments, the optical splitter may be configured to split the light beam into a sample beam and a reference beam. In some embodiments, the sample arm may be configured for the sample beam to pass through. In some embodiments, the sample arm may comprise: a polarization controller (202), and a polarization delay unit (PDU). In some embodiments, the PDU may be configured to give polarization-dependent group delays to the sample beam.

In some embodiments, the reference arm (302) may be configured for the reference beam to pass through. In some embodiments, the reference arm (302) may comprise: a single-mode optical fiber (207); a polarization controller (203); and an optical reflector (205) positioned at an end of the reference arm. In some embodiments, the optical combiner may be configured to combine the sample beam and the reference beam for interference to produce an optical signal. In some embodiments, the polarization-insensitive photodetector may be configured to detect a light power of the optical signal of the interference fed from the optical combiner. In some embodiments, the signal processing unit may be configured to acquire and process the detected optical power to produce PS-OCT image information.

In some embodiments, the light beam may be a spectrally broad or a spectrally swept light beam. In some embodiments, the sample arm may additionally comprise an optical retarder. As a non-limiting example, the optical retarder may comprise a quarter wave plate. In some embodiments, the polarization delay unit may produce a difference in optical path length between two polarization states; wherein the optical path length may be considered to be the distance light travels in a given optical system, typically starting from a light source to a detector; wherein supplementally the optical path length may be considered to be the product of the geometric length of the path followed by light through a given system, and the index of refraction of the medium through which it propagates. As a non-limiting example, the difference may be at least about 1 mm. As another non-limiting example, the difference may be within the range from 0.1 mm to 10 mm.

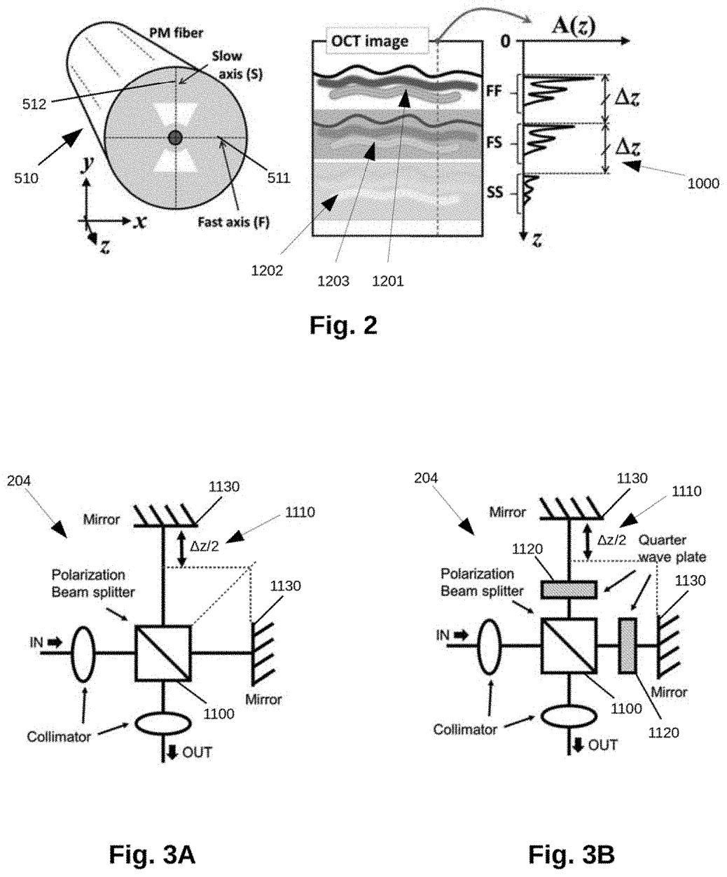

Referring now to FIG. 2, in some embodiments, the polarization delay unit may comprise a section of polarization maintaining fiber (510) with a fast axis (511) and a slow axis (512) of linear polarization. In some embodiments, the polarization delay unit may comprise: a polarization-dependent splitter, configured to split incoming light by polarization state into a plurality of beam components; an optical delay, imparted to one of the beam components; and an optical combiner, configured to recombine the plurality of beam components.

Referring now to FIG. 3A and FIG. 3B, in some embodiments, the PDU may comprise a polarization beam splitter (1100), configured to simultaneously function as both the polarization-dependant splitter and the optical combiner (206). In some embodiments, the PDU may comprise a pair of optical reflectors (1130), configured to reflect the beam components so as to form round-trip paths (1110), wherein the optical delay is formed by the length of the round-trip paths. In some embodiments, the PDU may comprise a pair of quarter-wave plates (1120), aligned in an orientation such that an optical axis of each plate is tilted by 45 degrees with respect to an optical axis of a linear polarization determined by the polarization beam splitter.

In some embodiments, the system may additionally comprise a polarization auto-setting unit, configured to monitor the system by the OCT image information. In some embodiments, the polarization controllers may be controlled by the polarization auto-setting unit.

In some embodiments, the polarization delay unit (204) may comprise a fast axis (511) and a slow axis (512). In some embodiments, a fast-fast (FF) image (1201) may be formed when the light propagates through only the fast axis, a slow-slow (SS) image (1201) may be formed when the light propagates only through the slow axis, and a fast-slow (FS) image (1203) may be formed when the light propagates through the fast axis in one direction and through the slow axis in the opposite direction.

In some embodiments, the present invention may feature a method of aligning the polarization of a PS-OCT system. As a non-limiting example, the method may comprise: adjusting a sample polarization controller (sPC) to minimize the amplitude of the SS image; setting the angle of a quarter-wave plate (QWP) to be 22.5 degrees with respect to the x axis; adjusting a reference polarization controller (rPC) to equalize the amplitudes of the FF image and the FS image; and setting the angle of the QWP to be 45 degrees with respect to the fast axis.

In some embodiments, the present invention may feature a polarization sensitive optical coherence tomography (PS-OCT) device comprising a polarization mode-dependant optical delay unit (PMOD) positioned such that a beam path has a double-pass through the PMOD. In some embodiments, the device may additionally comprise an optical retarder. In some embodiments, the PMOD may be configured to cause an optical delay, and a long cable (1301) within the device may be configured to cause an electrical delay to match the optical delay so as to synchronize a clocking signal of the device. As a non-limiting example, the long cable may be connected between a laser (100) and a computer (900) of the device.

In some embodiments, the present invention may feature a method of adding polarization sensitive capabilities to an optical coherence tomography (OCT) system. As a non-limiting example, the method may comprise: adding a polarization mode-dependent optical delay unit (PMOD) within a sample arm of the OCT system such that a beam path has a double-pass through the PMOD. In some embodiments, the method may further comprise aligning the polarization of the OCT system.

In one embodiment, a polarization alignment procedure may be performed using a manually adjusted polarization controller or automatic polarization controller. Without wishing to limit the invention to any particular theory or mechanism, it is believed that the polarization alignment procedure may allow for quantitative polarization sensitive data.

In some embodiments, the polarization mode-dependent delay unit may be an active delay or a passive delay unit. A passive polarization mode-dependent delay unit may include a polarization maintaining fiber (510) or a bulk optics-based delay. An active polarization mode-dependent delay unit may include an active electro-optic (EOM) and acousto-optic modulation (AOM) device. In some embodiments, the polarization mode-dependent delay unit may be incorporated into a common-patch imaging probe.

In some embodiments, the OCT system may be a time-domain system or a frequency-domain system. Frequency-domain OCT system includes swept-source OCT or spectral domain OCT system. In some embodiments, the operating wavelength of OCT system may include the visible range (400-800 nm), the NIR range (800 nm-1700 nm), or the mid-IR range (3-8 um). In some embodiments, the imaging device is not limited to OCT but also includes spectral-encoded microscopy and low coherence interferometer.

In some embodiments, a PM-fiber used as a polarization mode-dependent delay. Non-limiting examples of PM-fibers include: a bow-tie fiber, a PANDA fiber, a spun fiber, and other PM fibers.

In some embodiments, the present invention features a method for alignment of polarization so as to allow for quantitative data. In the polarization alignment procedure, a highly reflective sample is placed at the sample stage of the system. The sample must exhibit no birefringence. A glass plate or a mirror can be used for the purpose. The signal intensity of obtained OCT image and polarization controller attached to the original OCT system is used for polarization alignment.

FIG. 2 describes the expected OCT image as a result of placing a polarization mode-dependent optical delay unit. A Fast-Fast (FF) image will form when the light propagates through fast axis only. A Slow-Slow (SS) image will form when the light propagates through slow axis only. A Fast-Slow (FS) image will form when the light propagates through fast axis in one way and slow axis in another way.

As a non-limiting example, the alignment of polarization may involve the following steps:
Step 1—Adjust the sample polarization controller (sPC) for minimizing the amplitude of the SS image. Then, the output of the PM fiber is completely in the linearly polarized along fast axis. The FF image gets the brightest.
Step 2—Set the angle of the QWP to be 22.5-degree with respect to the x axis. Then, the sample-reflected field recoupled to the PM fiber is equally distributed to the fast axis and the slow axis.
Step 3—Adjust the reference polarization controller (rPC) for equalizing the amplitudes of the FF image and the FS image. Then, the reference field interferes with the sample fields in both of the polarization states equally.
Step 4—Set the angle of the QWP to be 45-degree with respect to the PM-fiber fast axis. Then, the sample-incident light is circularly polarized. From the non-birefringent sample, the sample field recoupled to the PM fiber is completely linearly polarized along slow axis. The FF image gets the darkest while the FS image becomes the brightest. The system is ready to take PS-OCT images.

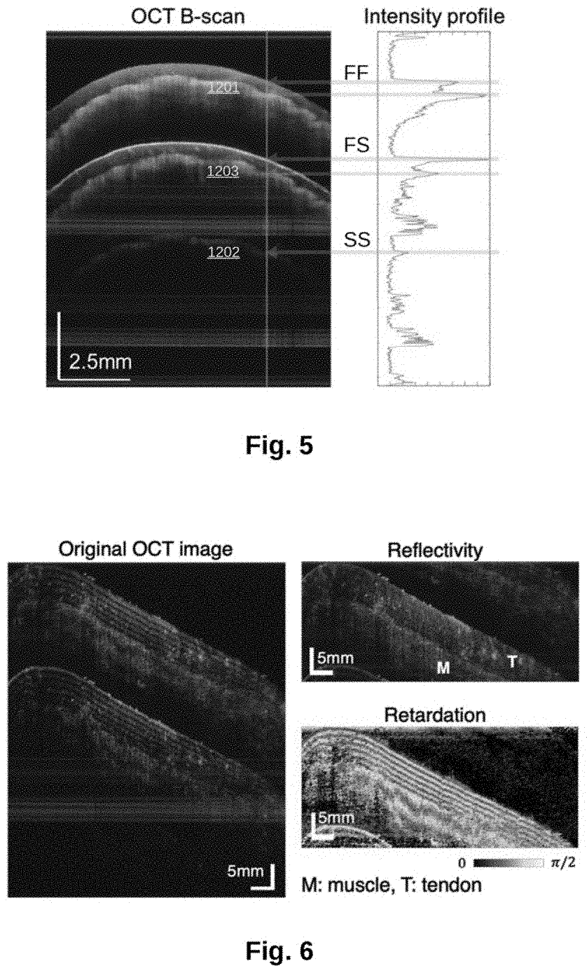

Referring now to FIG. 5, three images of a finger are present in a single OCT B-scan image. The intensity of the third image is very low as a result of linearly polarized incident light. Each image is 2.75 mm apart using a 12 m long PM fiber. Imaging artifacts from the reflection of QWP was present in the image as a result of long imaging range of our swept-source OCT system. The artifact can be easily removed by adjusting the position of the QWP in the sample arm. Alternatively, a low pass filter can be applied to remove high frequency signal from the output of balanced detector. Referring now to FIG. 6, the figure on the left shows two orthogonal polarization components of OCT light. The reflectivity image shows clear boundary between muscle and tendon. The retardation image shows the difference in birefringence pattern between tendon and muscle.

In some embodiments, the polarization delay unit produces a difference in optical path length between two polarization states as large as 1 mm or longer. Because of the signal attenuation, each image typically occupies an axial range of 1 mm or longer. Spatial discrimination of the polarization channels demands a spacing of 1 mm or larger. Otherwise channeled information may overlap.

In some embodiments, the devices and methods of the present invention may be used to detect the polarization properties of retain, coronary artery, genitourinary tissue, gastrointestinal tissue, and respiratory tract tissue.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

What is claimed is:

1. A polarization sensitive optical coherence tomography (PS-OCT) system comprising:
a. a light source (100), configured to produce a polarized light beam (101);
b. an optical splitter (201), configured to split the polarized light beam (101) into a sample beam and a reference beam;
c. a sample arm (301), configured for the sample beam to pass through, the sample arm (301) comprising:
i. a sample polarization controller (202); and
ii. a polarization delay unit (204) configured to give polarization-dependent group delays to the sample beam;
d. a reference arm (302), configured for the reference beam to pass through, the reference arm (302) comprising:
i. a single-mode optical fiber (207);
ii. a reference polarization controller (203); and
iii. an optical reflector (205) positioned at an end of the reference arm (302);
e. an optical combiner (206), configured to combine the sample beam and the reference beam for interference to produce an optical signal;
f. a polarization-insensitive photodetector (600), configured to detect a light power of the optical signal of the interference fed from the optical combiner (206); and
g. a signal processing unit (900), configured to acquire and process the detected optical power to produce PS-OCT image information.

2. The system of claim 1, wherein the polarized light beam (101) is a spectrally broad light beam or a spectrally swept light beam.

3. The system of claim 1, wherein the sample arm (301) additionally comprises an optical retarder.

4. The system of claim 3, wherein the optical retarder comprises a quarter wave plate (501).

5. The system of claim 1, wherein the polarization delay unit (204) produces a difference in optical path length (1000) between two polarization states.

6. The system of claim 5, wherein the difference in optical path length (1000) is at least about 1 mm.

7. The system of claim 1, wherein the polarization delay unit (204) comprises a section of polarization maintaining fiber (510) with a fast axis (511) and a slow axis (512) of linear polarization.

8. The system of claim 1, wherein the polarization delay unit (204) comprises:
a. a polarization-dependent splitter, configured to split incoming light by polarization state into a plurality of beam components;
b. an optical delay, imparted to one of the beam components; and
c. an optical combiner, configured to recombine the plurality of beam components.

9. The system of claim 1, wherein the polarization delay unit (204) comprises:
a. a polarization beam splitter (1100), configured to simultaneously function as both the polarization-dependent splitter and the optical combiner (206);
b. a pair of optical reflectors (1130), configured to reflect the beam components so as to form round-trip paths (1110), wherein the optical delay is formed by the length of the round-trip paths (1110); and
c. a pair of quarter-wave plates (1120), aligned in an orientation such that an optical axis of each plate is tilted by 45 degrees with respect to an optical axis of a linear polarization determined by the polarization beam splitter (1100).

10. The system of claim 1, wherein the system additionally comprises a polarization auto-setting unit, configured to monitor the system by the OCT image information.

11. The system of claim 10; wherein optionally the sample polarization controller (202) is controlled by a polarization auto-setting unit; wherein optionally the reference polarization controller (203) is controlled by the polarization auto-setting unit.

12. The system of claim 1, wherein the polarization delay unit (204) comprises a fast axis (511) and a slow axis (512).

13. The system of claim 12, wherein a fast-fast (FF) image (1201) is formed when the light propagates through only the fast axis (511), a slow-slow (SS) image (1202) is formed when the light propagates only through the slow axis (512), and a fast-slow (FS) image (1203) is formed when the light propagates through the fast axis (511) in one direction and through the slow axis (512) in the opposite direction.

14. A method of aligning the polarization of the system in claim 12, the method comprising:
a. adjusting a sample polarization controller (sPC) (202) to minimize the amplitude of the SS image (1202);
b. setting the angle of a quarter-wave plate (QWP) (501) to be 22.5 degrees with respect to the fast axis (511);
c. adjusting the reference polarization controller (rPC) (203) to equalize the amplitudes of the FF image (1201) and the FS image (1203); and
d. setting the angle of the QWP (501) to be 45 degrees with respect to the fast axis (511).

15. The device of claim 1, wherein the polarization delay unit (204) is positioned such that the beam path has a double pass through the polarization delay unit (204).

16. The device of claim 15, wherein the device additionally comprises an optical retarder.

17. The device of claim 15, wherein the PMOD is configured to cause an optical delay, and wherein a long cable (1301) within the device is configured to cause an electrical delay to match the optical delay, so as optionally to synchronize a clocking signal of the device, so as optionally to synchronize a trigger signal of the device.

18. The device of claim 17, wherein the long cable (1301) is connected between a light source (100) and a signal processing unit (900) of the device.

19. A method of adding polarization sensitive capabilities to an optical coherence tomography (OC T) system, comprising:
a. adding a PMOD within a sample arm (301) of the OCT system such that a beam path has a double-pass through the PMOD.

20. The method of claim 19, wherein the method further comprises aligning the polarization of the OCT system, wherein the PMOD is an active delay or a passive delay; wherein the PMOD includes (a) a passive polarization maintaining fiber (510), (b) a passive bulk optics-based delay, (c) an active electro-optic module (EOM), or (d) an active acousto-optic module (AOM); wherein the PMOD may be incorporated into a common-patch imaging probe.
